(19) United States
(12) Patent Application Publication
(10) Pub. No.: US 2026/0367408 A1
(43) Pub. Date: Nov. 19, 2026

(54) PRESCRIPTION LENS ATTACHMENT FOR AUGMENTED REALITY GLASSES

(71) Applicant: Snap Inc., Santa Monica, CA (US)

(72) Inventors: Mathias Andreas Hintermann, Santa Monica, CA (US); Miller Harry Schuck, III, Erie, CO (US); Michael Ryner, Castro Valley, CA (US); Daniel Paul Rhodes, Eynsham (GB); Robert Edward Stevens, Eynsham (GB)

(21) Appl. No.: 19/672,210

(22) Filed: May 8, 2026

Related U.S. Application Data
(60) Provisional application No. 63/805,121, filed on May 13, 2025.

(51) Int. Cl. G02B 27/01; G02B 3/04; G02C 3/02; G02C 5/00; G02C 5/06; G02C 7/02

(52) U.S. Cl. CPC G02B 27/0172; G02B 3/04; G02B 27/0176; G02C 3/02; G02C 5/008; G02C 5/06; G02C 7/02; G02B 2027/0178; G02B 2027/0194; G02C 2202/02; G02C 2202/16

(57) ABSTRACT

Examples relate to prescription lens systems for augmented reality headsets. A prescription lens attachment apparatus includes a flexible frame with vertical compliance that supports prescription lenses having a front surface curvature matching the eye-side lens of the AR headset. The frame utilizes stamped stainless steel with either groove cuts, T-rim cuts, or Metal in line cuts in the lenses, enabling a two-step assembly process where the frame is pushed into the nose area and clicked into place. The prescription lenses employ aspheric surfaces optimized through field curvature matching to maintain optical performance comparable to traditional eyewear while accommodating decentration of up to 4mm, providing users with proper optical correction for both real-world and AR imagery in a compact, lightweight design.

### CLAIM OF PRIORITY

This patent application claims the benefit of priority to Hintermann et al, U.S. Provisional Patent Application Serial Number 63/805, 121, entitled "PRESCRIPTION LENS ATTACHMENT FOR AUGMENTED REALITY GLASSES," filed on May 13, 2025, which is hereby incorporated by reference herein in its entirety.

### TECHNICAL FIELD

The present disclosures relate to eyewear systems and, in some examples, to optical lenses and attachment mechanisms for prescription lenses in augmented reality (AR) headsets, such as AR glasses.

### BACKGROUND

AR headsets such as AR glasses combine digital content with the real world through augmented content presentation and optical systems. These optical systems typically comprise a waveguide that generates images at infinity, complemented by a set of lenses that adjust the focal distance of the AR headset and maintain proper viewing of the real environment. Manufacturing constraints for AR systems typically require waveguides to be flat, with surrounding lenses designed to minimize overall thickness. This configuration typically includes a negative power lens behind the waveguide and a positive power lens in front, with flat surfaces facing the waveguide.

Traditional prescription eyewear follows established optical design principles based on the Tscherning ellipse, where specific base curves are selected to minimize optical aberrations across different prescription strengths. As described in more detail below, standard ophthalmic lenses utilize varying front surface curvatures depending on the prescription power, creating a range of lens profiles from highly curved to relatively flat.

When combining AR technology with vision correction, a prescription element should preferably be positioned behind the AR lens stack to properly correct both real-world and the AR imagery. This positioning creates inherent design challenges as the prescription lens must interface with the AR optics while maintaining proper optical performance.

A mismatch between traditional ophthalmic lens designs and AR optical requirements can lead to compromises in fit, thickness, and optical performance. More positive prescription lenses tend to create gaps around the edges when paired with AR optics, while more negative prescriptions may position the lens center uncomfortably close to the eye. Aspheric lens designs can offer potential solutions to these optical challenges but introduce additional complexities regarding alignment sensitivity and manufacturing tolerances.

### BRIEF DESCRIPTION OF THE DRAWINGS

Throughout the drawings, reference numbers may be re-used to indicate correspondence between referenced elements. The drawings are provided to illustrate examples of the subject matter described herein and not to limit the scope thereof.

FIG. 1 illustrates an AR lens stack comprising a waveguide, a negative power lens, and a positive power lens, according to some examples.

FIG. 2A illustrates an example ophthalmic RX lens array, according to some examples.

FIG. 2B illustrates an example AR RX lens array, according to some examples.

FIG. 3A illustrates a conventional prescription lens more curved than the rear lens of an AR headset, showing air gaps around the edges, according to some examples.

FIG. 3B illustrates a conventional prescription lens flatter than the rear lens of an AR headset, showing an air gap in the middle, according to some examples.

FIG. 4 illustrates a graph showing typical surface curvatures for standard spherical ophthalmic lenses, according to some examples.

FIG. 5A-5D illustrate example field curves from ophthalmic lenses across a range of gaze angles, according to some examples.

FIG. 6A-6B illustrates a comparison of optical power maps for AR prescription lenses and standard ophthalmic lenses in an on-axis (on center) configuration, according to some examples.

FIG. 7A-7B illustrates a comparison of optical power maps for AR prescription lenses and standard ophthalmic lenses in an off-axis (decentered) configuration, according to some examples.

FIG. 8 illustrates a flexible frame with vertical compliance for prescription lens attachment, according to some examples.

FIG. 9A illustrates aspects of mounting a prescription lens frame to an AR headset, according to some examples.

FIG. 9B illustrates further aspects of mounting a prescription lens frame to an AR headset, according to some examples.

FIG. 9C illustrates a completed mounting of a prescription lens frame to an AR headset, according to some examples.

FIG. 10A illustrates a top side view of a frame with a prescription lens designed to match the rear curvature of an AR headset's eye side lens, according to some examples.

FIG. 10B illustrates a top/front perspective view of a frame supporting a pair of prescription lenses with matched-curvature front surfaces, according to some examples.

FIG. 10C illustrates further aspects of a frame, according to some examples.

FIG. 11 shows example operations in a method for integrating prescription correction into an augmented reality (AR) headset, according to some examples.

### DETAILED DESCRIPTION

Some examples described herein address challenges related to the integration of optical prescription or correction into AR headsets. Unless the context indicates otherwise, the term AR headset as used herein is intended to cover relatively large head-wearable AR and virtual reality (VR) headsets, helmets, or goggles that might, for example, provide a tight or light-excluding fit over a user's eyes. The term is also intended to cover relatively light or smaller AR headsets also known as “glasses” or “spectacles” in some examples. Some examples disclosed herein seek to provide prescription correction in such AR headsets viewed collectively and generally integrate two complementary technologies: a matched-curvature optical design for a prescription lens and a lightweight attachment mechanism of the prescription lens to an AR headset.

As mentioned above, AR headsets typically employ a three-component optical system. A waveguide generates images at infinity, a negative power lens behind the waveguide adjusts the apparent image position to a more natural viewing distance of approximately 1-2 meters, and a positive power lens in front of the waveguide compensates for the negative lens to maintain normal real-world viewing. Manufacturing constraints typically require waveguides to be flat, with surrounding lenses designed to minimize overall thickness by incorporating flat surfaces toward the waveguide. When users require vision correction, prescription elements should preferably be positioned behind the AR lens stack to correct both real-world and AR imagery. This positioning creates inherent design challenges as traditional ophthalmic lenses follow the Tscherning ellipse principle, where specific base curves minimize optical aberrations across different prescription strengths.

A first aspect of some examples disclosed herein addresses the optical design challenges mentioned above. Traditional ophthalmic lenses feature varying front surface curvatures based on prescription power, creating a mismatch with the AR lens stack's rear surface. This mismatch results in either gaps around the edges (with positive prescriptions) or positions the lens center uncomfortably close to the eye (with negative prescriptions). On the contrary, disclosed examples seek to address this challenge by maintaining a matching curvature or a fixed front radius on prescription lenses that precisely (or at least closely) matches the curvature of the AR headset's "eye side" lens. As described in more details below, this matching curvature allows the prescription lenses to be positioned closer to the eye side lens, creating a more compact design while maximizing eye relief when the prescription lenses are in use.

To compensate for deviating from traditional best-form lens designs, some disclosed examples herein employ aspheric lens surfaces. In some examples, a lens design or optimization process targets field curves matching those of standard ophthalmic spherical prescriptions and seeks to provide users with a familiar visual experience while maintaining tolerance to decentration that exceeds other designs such as point-focal or Percival form lenses.

Some examples of a prescription lens herein include one or more aspheric surfaces optimized through field curvature matching to provide consistent optical power distribution across the lens surface, enabling accurate focus of both real-world and augmented reality imagery across a wide field of view, even when the lenses are not perfectly aligned with the user's optical axis. The aspheric lens design compensates for deviating from traditional best-form designs while maintaining proper optical correction over a large field of view (FOV).

Some field curvature matching methods seek to ensure that a prescription lens for an AR headset delivers consistent optical performance across the lens surface, allowing users to clearly view AR content regardless of where they look through the lens. For example, a prescription lens may maintain proper optical power distribution even when decentered by up to 4 millimeters (mm), as demonstrated by some example power map comparisons provided further below, seeking to ensure that AR content remains clear despite normal movement or adjustment of the glasses.

In some examples, a prescription lens design or optimization specifically targets sagittal and tangential field curves that provide optimal focus for both real-world objects and AR imagery projected through the waveguide system. In some examples, a prescription lens design ensures proper correction of both real-world and AR imagery when positioned behind the AR lens stack, allowing users to transition conveniently between viewing their environment and digital content without visual distortion.

Comparative analysis of optical power maps demonstrates that some example optimized AR prescription lenses described herein closely match the optical performance of standard ophthalmic lenses, both when centrally aligned and when decentered by up to 4mm. This tolerance to misalignment may be particularly helpful in real-life wearable applications where perfect alignment of an AR headset cannot be guaranteed.

A second aspect of some examples addresses challenges arising when one considers how best to integrate a prescription lens conveniently or “seamlessly” into an AR headset. Some examples include a flexible frame material, for example, a stamped flat stainless steel (SUS) frame that has inherent flexibility. The flexibility of some example frames described herein provides or endows the frame with what is termed “vertical compliance”. Vertical compliance in the context of some examples herein of a prescription lens attachment system refers to the ability of a lens frame, for example a flexible stamped stainless steel frame, to flex or bend in a vertical direction, allowing the prescription lenses to be displaced relative to one another or move radially apart during mounting to an AR headset, such as AR glasses.

As described further below, this vertical compliance can provide a helpful feature that allows frame retention elements to accommodate a larger tolerance range in the mating features of the glasses, thus keeping a snap feel and retention force consistent. The flexible nature of the steel material enables the frame to temporarily deform during installation, for examples facilitating a two-step user assembly process where the frame is first pushed into the center area of the nose bridge of the AR headset and then clicked into place.

In some examples, this compliance also enables the prescription lens attachment to adapt to slight variations in the AR glasses' dimensions, ensuring a secure fit without requiring extremely tight manufacturing tolerances. During mounting, the vertical compliance allows the prescription lenses to move apart slightly to clear the nose bridge area of the AR glasses before snapping into their final position.

Furthermore, unlike traditional prescription attachments that might use magnets or heavy mechanisms, for example, disclosed examples herein seek to leverage the material flexibility of sheet metal to create a lightweight, easy-to-use solution. The minimal features and reduced material complexity seek to simplify prescription lens attachment configurations compared to existing systems. In some examples, a prescription lens incorporates either a groove cut, or a "T-rim", or "metal in line" cut that interfaces with the steel frame.

In general, some described examples herein seek to offer several technical benefits over conventional solutions. Most display eyewear products integrate prescription correction through additive components that increase weight and complexity. The lightweight, non-additive attachment mechanism of some examples herein minimizes added weight while maintaining optical performance. The matched curvature between prescription lenses and AR optics eliminates gaps that would otherwise create a thicker frame assembly, difficult mounting features, shorter eye relief, and potentially degraded optical performance. The field curvature matching optimization algorithm ensures similar user experience to conventional eyewear while providing wide decentration tolerance. Through an integrated approach to both optical and mechanical design, disclosed examples herein seek to enable AR headset users who require vision correction to experience both digital content and the real world with proper optical correction, without the bulk and complexity of conventional solutions.

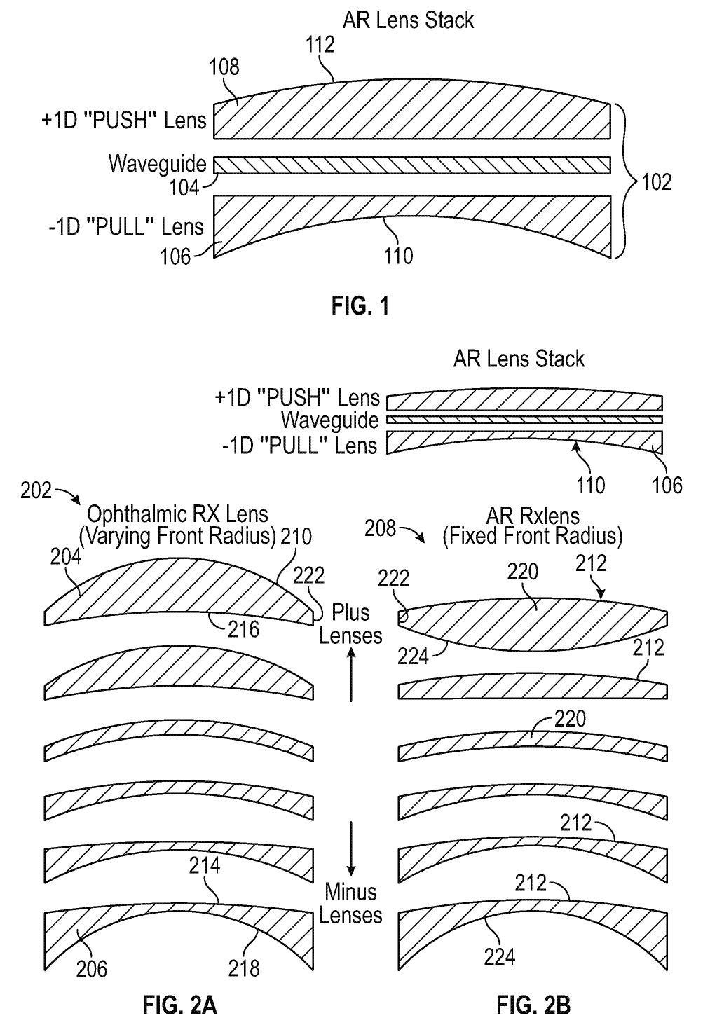

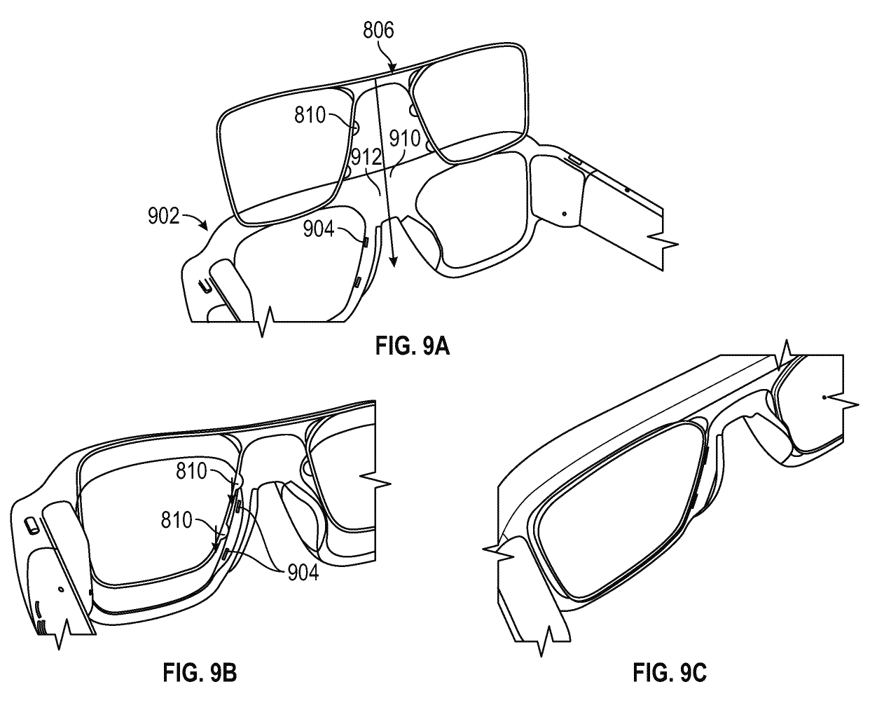

With reference to FIG. 1, an AR headset (for instance, an AR headset 902 in the example form of the AR “glasses” shown in FIG. 9A) typically includes an internal AR lens stack 102 comprising a waveguide 104 to generate an image at infinity, a negative power lens 106 behind the waveguide 104 to adjust the apparent position of the image to be at a more “real-world friendly” distance of about 1-2m, and a positive power lens 108 in front of the waveguide 104 to compensate for the focal power of the negative power lens 106 so that the real world can be viewed normally.

Current manufacturing limitations for waveguides typically mean that the waveguide has to be flat, and to minimize the overall thickness of the AR imaging lenses in the AR lens stack 102 the lens on either side of the waveguide 104 typically has a flat surface facing towards or nearest the waveguide 104, as shown in FIG. 1. For imaging and focusing reasons, this arrangement typically leads the rear surface 110 of the minus lens (i.e., the negative power lens 106) to assume a concave shape, and the front surface 112 of the plus lens (i.e., the positive power lens 108) to assume a convex shape as shown in FIG. 1. An optical prescription or vision correction element for a user of the AR headset 902 should preferably be fitted behind the AR lens stack 102 so that both the real world and AR image can be corrected, but this can lead to some complications as described further below.

FIG. 2A shows an example ophthalmic RX lens array 202 of conventional ophthalmic prescription lenses, each having a varying front radius of their front surface, for example as shown. Traditional ophthalmic lenses of the type shown in in ophthalmic RX lens array 202 (FIG. 2A) are typically designed around the ideal of the Tscherning ellipse wherein an optimal base curve can be selected to minimize optical aberrations. By way of contrasting conventional examples, the top conventional prescription lens 204 in the ophthalmic RX lens array 202 has a very convex front surface 210 and a flatter concave rear surface 216, whereas the lowest conventional prescription lens 206 in the ophthalmic RX lens array 202 has a flatter convex front surface 214 and a deeply concave rear surface 218.

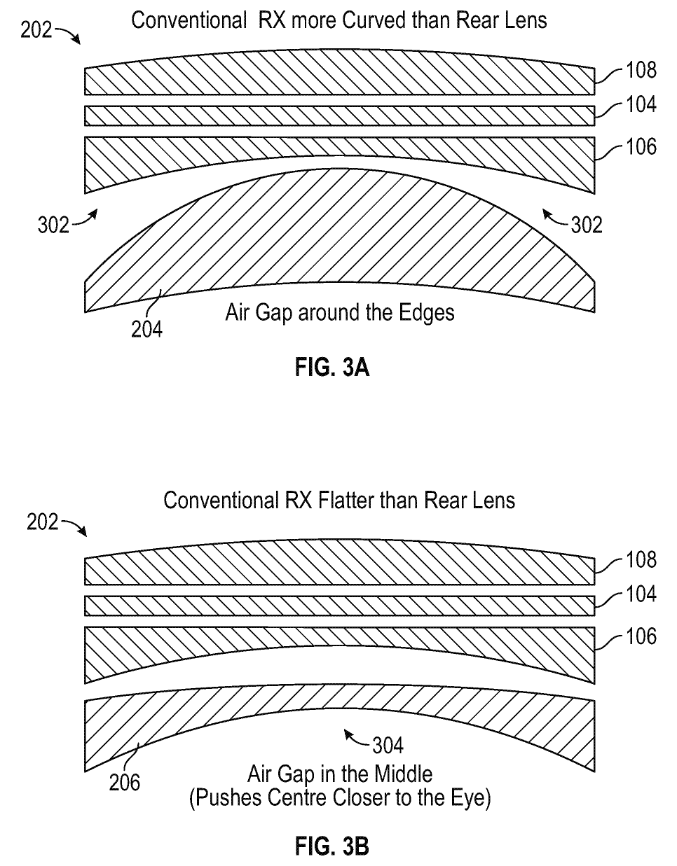

If these conventional lenses 204 and 206 were sought to be used as an optical correction or prescription element for an AR headset, for example in the manner shown in FIGS. 3A and 3B, the use of the “bulbous” conventional prescription lens 204 (FIG. 3A) would leave considerable airgaps 302 around the edges of the lens (i.e., around the “bulge”), while the use of the “flatter” conventional prescription lens 206 (FIG. 3B) would leave a significant airgap 304 in the middle of the lens, albeit bringing the center of the conventional prescription lens 206 closer to the user's eye in use.

Neither of these situations is ideal from the point of view of efficiency of overall space utilization and/or optical correction or power. Generally speaking, a mismatch of lens radius impacts on the thickness of the lens stack. More positive lenses will result in a gap around the edge of the AR stack and the prescription lens. More negative lenses might be too flat to fit behind the AR stack, this will not increase the edge thickness, but does bring the center of the lens closer to the eye.

In contrast, with reference to FIG. 2B, there is shown an AR RX lens array 208 in which each AR prescription lens 220 in the array has a front surface having a curvature that matches the curvature of the rear surface of the negative power lens. In some examples, the entire area or at least a portion of the front surface 212 of the AR prescription lens 220 has a fixed or common radius that, in some examples, matches the curvature of the rear surface 110 of the adjacent negative power lens 106 when fitted to an AR headset 902. In fitting the AR prescription lens 220 to match the concave surface of the negative power lens 106 some examples herein thus deviate from the conventional optical approaches in fitting an optical correction or prescription element into an AR headset. Indeed, in some examples, due to the low power of the negative power lens 106, a biconvex AR prescription lens 220 may be used for some positive power prescriptions. Biconvex lenses are very seldom, if ever, used in conventional optical correction methods.

The ophthalmic RX lens array 202 of FIG. 2A and the AR RX lens array 208 of FIG. 2B thus seek to show a comparison of standard ophthalmic lenses against some present prescription lens examples proposed for a best-fit behind the lenses of an AR headset. The edge thicknesses 222 of the lenses in each array may be comparable in some instances, but ultimately the variation in the front radius of the standard ophthalmic means that they will not fit well behind the AR lens stack 102 in most cases.

In some further examples of an AR prescription lens 220 disclosed herein, one or more aspheric lens designs may be used in order to further reduce optical aberrations. In this regard, it is known that the larger the aspheric component of a given lens, the less tolerant it is likely to be to misalignment away from, or being centered on, the optical axis of the lens. Some examples of an AR prescription lens 220 disclosed herein seek to provide a compromise between optical performance and position tolerance. In some examples, an aspheric surface may be provided on a rear surface 224 of an AR prescription lens 220 (FIG. 2B), and/or be provided on a front surface 212 of an AR prescription lens 220, while still seeking to match the curvature of the front surface 212 of the AR prescription lens 220 with the rear surface 110 of the negative power lens 106.

Some examples of an AR prescription lens 220 seek to use field curves of a standard ophthalmic spherical prescription as targets for the optical design of the AR prescription lens 220. By trying to match the on-axis properties of a normal pair of spectacles, an AR headset 902 wearer using an AR prescription lens 220 attached thereto may enjoy a more familiar user experience of the real world. Furthermore, in some cases, this type of lens design may also be more tolerant to decentration than other designs such as those of point-focal or Percival-form lenses.

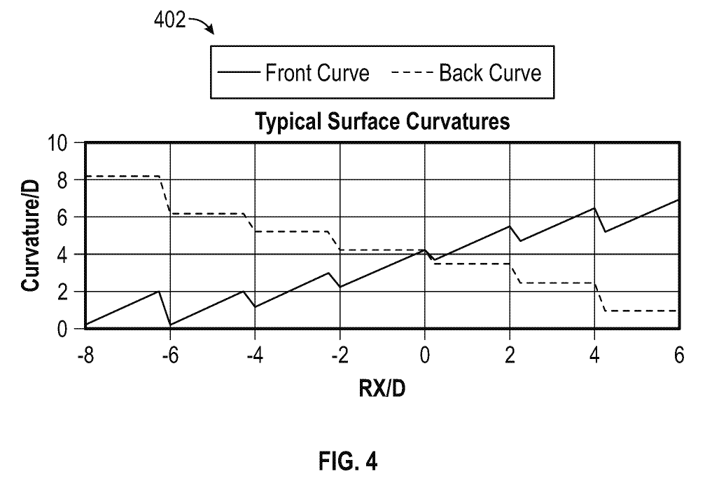

Reference is now made to FIG. 4 in this regard. The graph 402 in this view shows typical curvatures (in a 1.53 refractive index) for standard spherical ophthalmic lenses. In some examples, with these comparative values in mind as targets, optical power and correction ranges for an AR prescription lens 220 are designed and/or created in groups with each lens in a group having matched curvature, or a single fixed, or common, front surface radius. Some prescription lens ranges are created over a two diopter range approximately, in some examples.

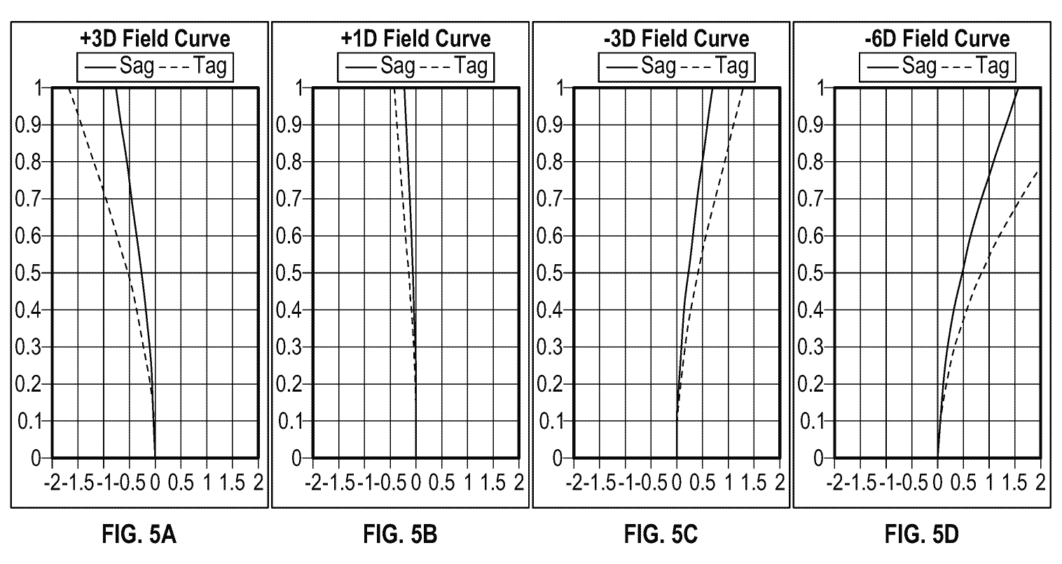

As further example optical targets, reference is now made to FIG. 5A - FIG. 5D. These views show example field curves from ophthalmic lenses and a range of gaze angles of about 45 °. In some examples, these values are used to generate targets for optimization of an AR prescription lens 220 having matched curvature, or a one fixed or common front surface radius.

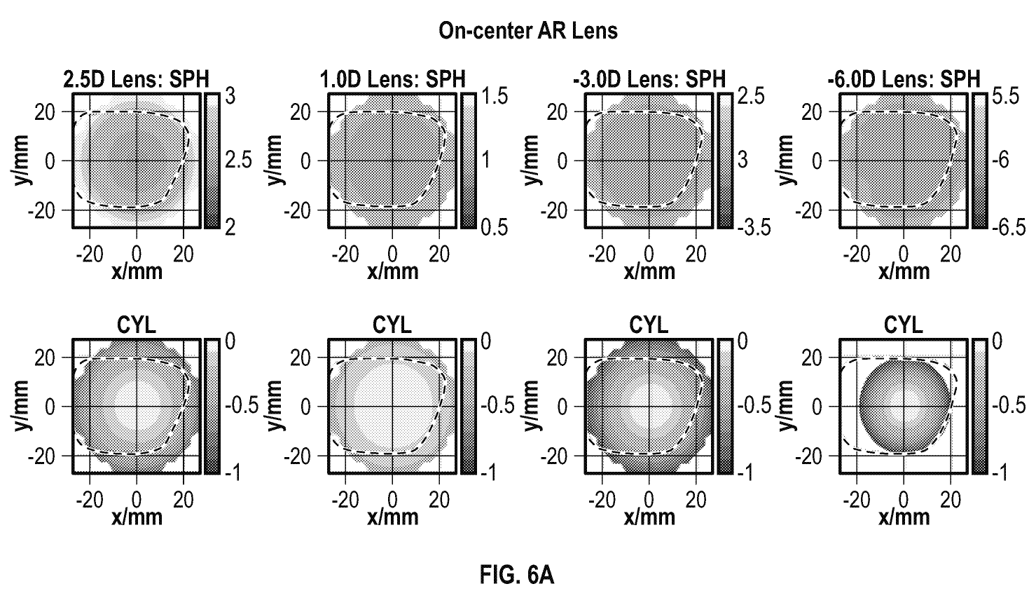

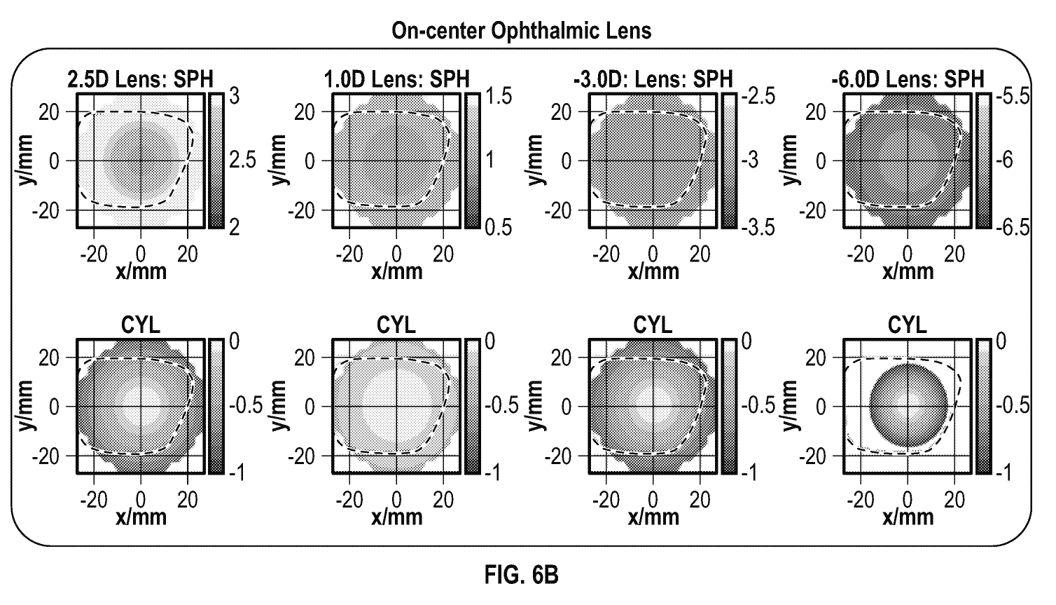

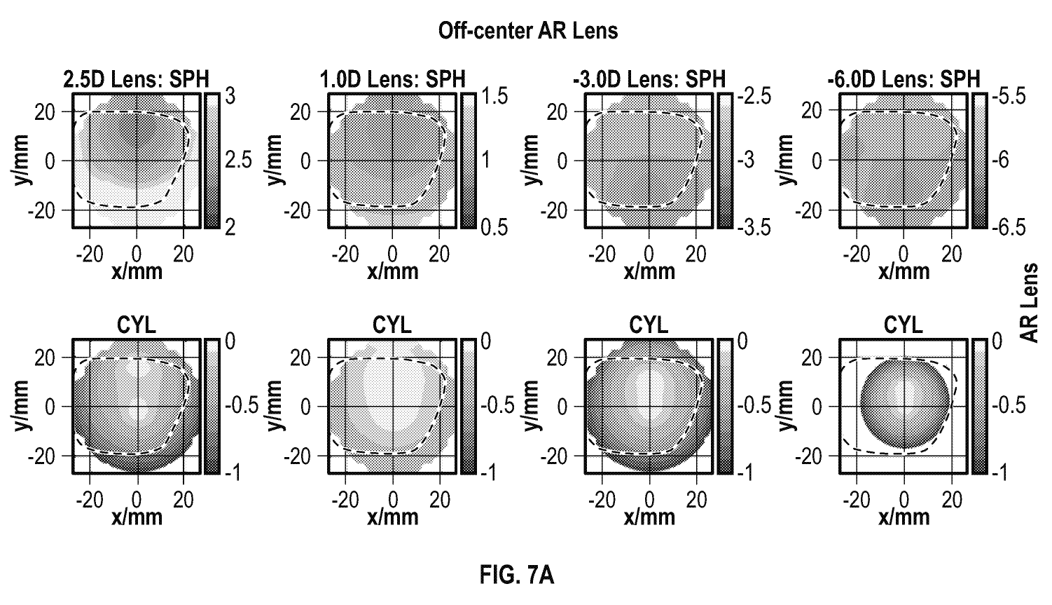

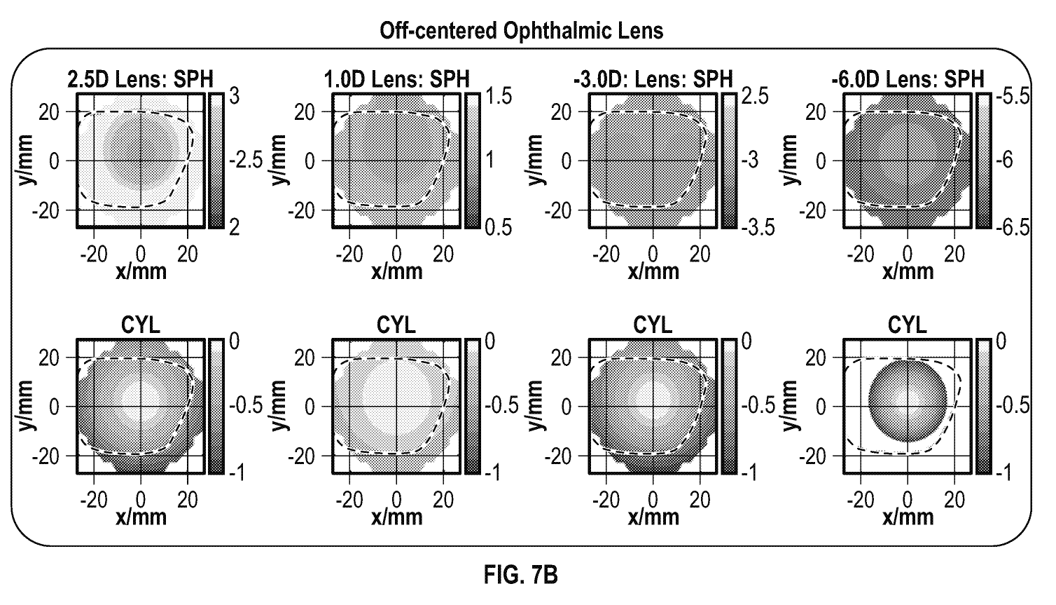

The views of FIGS. 6A and 6B show a comparison of optical power maps for a range of AR prescription lens 220 against standard off-the-shelf ophthalmic lenses. The views in FIG. 6A-6B show results for on-axis lenses while the lenses used to generate the results of FIGS. 7A-7B were decentered of their optical axis by 4 mm. It may be observed that the on-axis (on center) results of FIG. 6A show a good match by an AR prescription lens 220 with its respective conventional on-axis (on center) target (i.e., of standard ophthalmic design) in FIG. 6B. The 4 mm decentered (off axis) results in FIG. 7A for an AR prescription lens 220 are likewise close to their decentered (off axis) optical targets of FIG. 7B.

With these optical targets in mind, in some examples, the design and adjustment of the rear or aspheric surfaces of an AR prescription lens (for example an AR prescription lens 220) may include an optimization process that maintains a matching curvature, and/or a fixed front surface curvature, while achieving the desired or targeted optical correction.

The rear surfaces of the AR prescription lenses are designed in some examples using an aspheric optimization approach that targets field curves matching those of standard ophthalmic spherical prescriptions. This optimization process seeks to ensure that while the front surface remains constant to match the curvature of the AR headset's negative power lens, the rear surface of the AR prescription lens 220 is precisely adjusted to provide the required optical correction. To compensate for deviating from traditional best-form lens designs, the technology employs aspheric lens surfaces. The optimization process targets field curves matching those of standard ophthalmic spherical prescriptions. In some examples, this approach provides users with a familiar visual experience while maintaining tolerance to decentration that exceeds other designs such as point-focal or Percival form lenses.

The aspheric surfaces are implemented on the rear surface of the AR prescription lenses while maintaining a fixed front radius that precisely matches the curvature of the AR headset's "eye side" lens. This matching curvature allows the prescription lenses to be positioned closer to the eye side lens, creating a more compact design while maximizing eye relief when the prescription lenses are in use. The technical implementation involves one or more aspheric surfaces that are optimized through field curvature matching to provide consistent optical power distribution across the lens surface, enabling accurate focus of both real-world and augmented reality imagery across a wide field of view, even when the lenses are not perfectly aligned with the user's optical axis.

In some examples, field curves from ophthalmic lenses are used across a range of gaze angles (for example, approximately 45°) to generate targets for optimization of the AR prescription lenses. In practical terms, unlike conventional ophthalmic lenses in which the front surface curvature is varied across different prescription ranges to optimize optical performance for each range, the AR prescription lenses 220 described herein must share a single common front surface curvature that matches the AR headset's eye-side lens regardless of prescription strength. Because this fixed front curve is, by definition, sub-optimal for the majority of the prescription range, each individual prescription requires dedicated aspheric optimization of the rear surface to compensate. For manufacturing and design convenience, AR prescription lenses 220 may be organized in groups (over approximately a two-diopter range), with each lens within a group sharing the same single common front surface radius matched to the AR headset's eye-side lens; the grouping does not imply different front curves for different prescription ranges, as would be the case in conventional ophthalmic design, but rather provides a structured approach to the rear-surface optimization across the full prescription range.

Some examples seek to offer several benefits. The aspheric lens design compensates for deviating from traditional best-form designs while maintaining proper optical correction over a large field of view (FOV). The field curvature matching optimization ensures the prescription lenses maintain optical performance even when decentered by up to 4mm, as demonstrated by the power map comparisons. This tolerance to misalignment may be particularly valuable in real-life wearable applications where perfect alignment cannot be guaranteed. By matching the curvature between the prescription lens and the AR optics, the design eliminates gaps that would otherwise create a thicker frame assembly, difficult mounting features, shorter eye relief, and potentially degraded optical performance. By targeting the field curves of standard ophthalmic lenses, the design provides users with a familiar visual experience despite the unconventional lens configuration. The lens design ensures proper correction of both real-world and AR imagery when positioned behind the AR lens stack, allowing users to transition conveniently between viewing their environment and digital content without visual distortion.

The comparative analysis of optical power maps demonstrates that these optimized AR prescription lenses closely match the optical performance of standard ophthalmic lenses, both when centrally aligned and when decentered, providing a technical solution that effectively integrates prescription correction into AR headsets without compromising optical quality or user comfort.

Thus, some examples of an AR prescription lens 220 described herein seek to provide a method of providing prescription lens correction in an AR headset that seeks to ensure tight mechanical mating of the prescription lenses in an augmented reality headset while simultaneously preserving the optical correction over a large field of view (FOV) and tolerant pupil-position that a user would have with more typical off-the-shelf prescription lenses. Conventionally, prescription lenses do not mate well into AR eyewear creating a thicker frame assembly and often requiring difficult mounting features that are typically implemented in the frame, shorter mechanical eye relief (e.g. where the user's eyelashes touch the lenses), and potentially poorer optical performance due to the position of the eye relative to the prescription lenses. Implementing a curvature match between a negative power lens 106 and an AR prescription lens 220 helps with mating, and in some examples is enhanced by matching optimization methods to ensure similar user experience and a wide decentration tolerance.

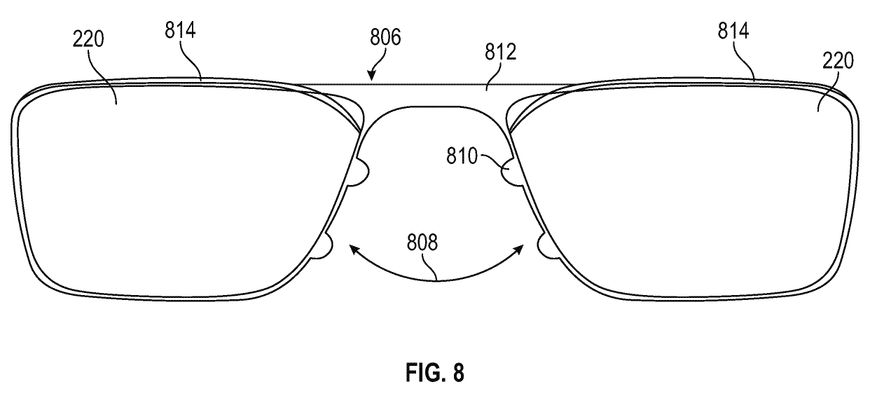

Reference is now made to FIGS. 8-10C These views illustrate example aspects of a prescription lens attachment apparatus for mounting a prescription lens, such as an AR prescription lens 220, to an AR headset such as the AR headset 902, for example.

With reference to FIG. 8, an example frame 806 is shown for attaching a prescription lens, in this case a pair of prescription lenses, to an AR headset. The frame 806 has a central frame nose bridge 812 and two rings or eye wires 814 each holding a respective AR prescription lens 220 therein. In some examples, the eye wires 814 are part of the frame 806 and surround the lenses, securing them in place. In full-rim frames 806, the eye wires 814 may completely encircle the lenses, while in half-rim or rimless frames, alternative methods like nylon cords or screws may be used to secure the lenses.

In some examples, the frame 806 is flexible and configured to provide what is referred to further above as vertical compliance. In some examples, vertical compliance may enable a vertical compliance flexibility 808 (as indicated by the directional arrow of FIG. 8 for example) which allows an AR prescription lens 220, in this case a pair of prescription lenses, to be inserted conveniently into an AR headset 902 and held there securely.

Generally speaking, vertical compliance in the context of some examples of a prescription lens attachment system refers to the ability of a lens frame, for example a frame 806, to flex or bend in a vertical direction, allowing prescription lenses attached there to move or “flex” away relative to one another in a lateral and upwards direction, or radially apart, during mounting to AR headset. As mentioned above, vertical compliance can provide a helpful feature that allows frame retention elements 810 (such as tabs or other detent formations) to accommodate a larger tolerance range in the mating of the frame 806 with the AR headset 902.

For example, with reference to FIGS. 9A-9C, one or more of the frame retention elements 810 may engage in, or be received by, one or more respective retention slots 904 provided in the AR headset 902 when the frame 806 is mounted to the AR headset 902. The vertical compliance flexibility 808 (shown in FIG. 8) seeks to enable a “snap” or “click” feel when the frame 806 is inserted into the AR headset. The vertical compliance also provides a consistent frame retention force when these are in place, for example as shown in FIG. 9C.

In some examples, vertical compliance enables the prescription lens attachment to adapt to slight variations in the AR glasses' dimensions, ensuring a secure fit without requiring extremely tight manufacturing tolerances. During mounting of the frame 806, the vertical compliance allows each of the prescription lenses to move apart slightly from one another to clear the nose bridge area of the AR glasses before snapping into their final position (shown FIG. 9C).

In some examples, the frame 806 is formed from a flexible sheet material, such as stamped flat stainless steel (SUS) that may enjoy inherent flexibility. The flexible nature of the steel material enables the frame 806 to deform temporarily during installation into the AR headset 902, for example facilitating a two-step user assembly process in some examples wherein the frame 806 is first pushed into a central area 910 (FIG. 9A) of the AR nose bridge 912 of the AR headset 902, and then clicked into place, for example by the insertion of one or more frame retention elements 810 into a respective retention slot 904 (FIG. 9B). Other engagement formations or arrangements are possible. In some examples, the sheet metal material of the frame 806 can be optimized further for weight, assembly of lenses, and other factors to take advantage of overall weight reduction. In some examples, the steel material is designed or selected to flex just enough during the installation process, facilitating a secure fit while maintaining lightweight properties compared to conventional prescription attachment mechanisms that may use magnets or heavier components.

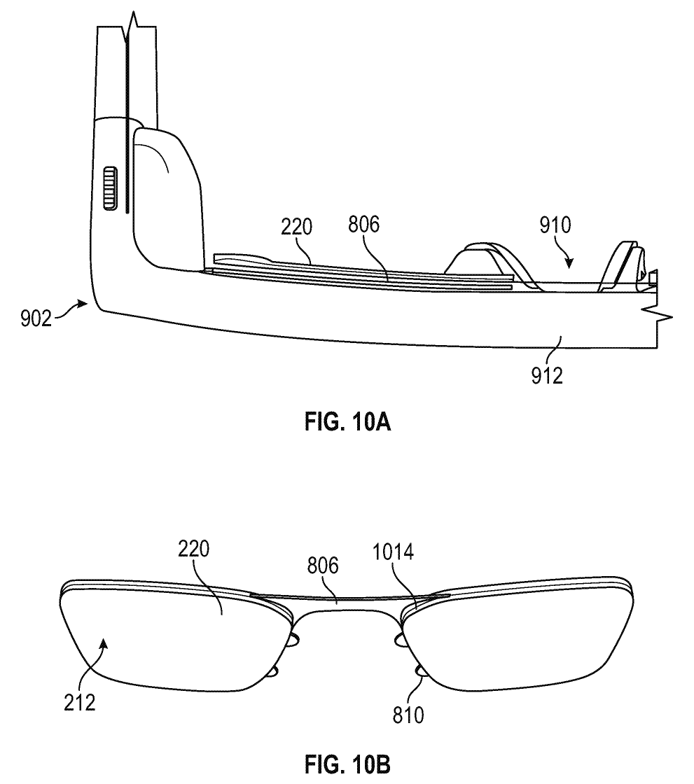

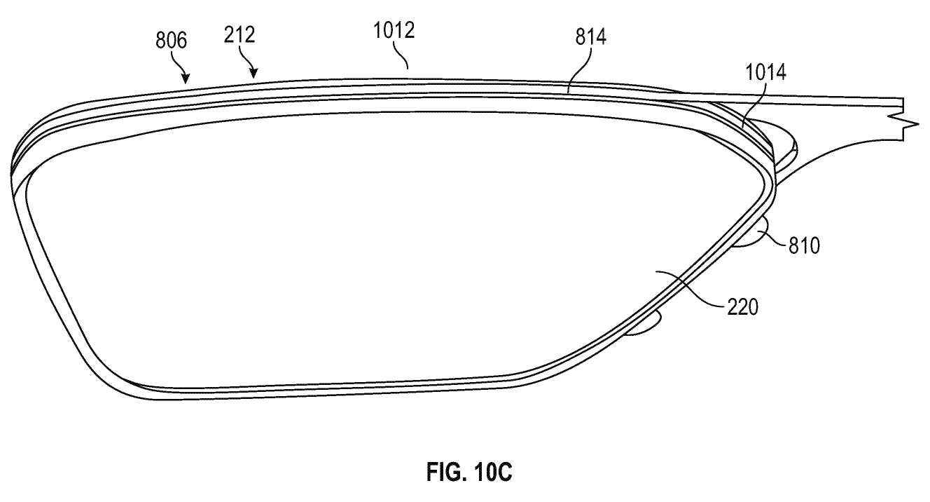

FIG. 10A shows a top side view of a portion of an example frame 806 with a front surface of the AR prescription lens 220 that is designed to match the rear curvature or rear surface of a negative power lens 106 (eye side lens) of an AR headset 902.

FIG. 10B provides a top/front perspective view of the frame 806 supporting a pair of AR prescription lenses 220, showing a matched-curvature front surface of each AR prescription lens 220. In some examples, the matched-curvature front surface is, or at least includes a front surface 212 that matches the rear curvature or rear surface of a negative power lens 106 (eye side lens) of an AR headset 902 allowing for a more compact overall design and seeking to improve eye relief (minimize eye strain) when the AR prescription lenses 220 are in use.

FIG. 10C illustrates further aspects of an example AR prescription lens 220, for example a flat portion 1012 that may extend around the entire periphery of the AR prescription lens 220 across the top, bottom, and sides of the AR prescription lens 220. Also shown is an example peripheral "T-rim" or metal-in-line cut 1014 formed in the AR prescription lens 220 that interfaces with the flexible frame 806 and holds it securely in the eye wire 814. In some examples, the cut 1014 interfaces with the stamped steel frame, providing secure attachment while maintaining the lightweight nature of the overall assembly.

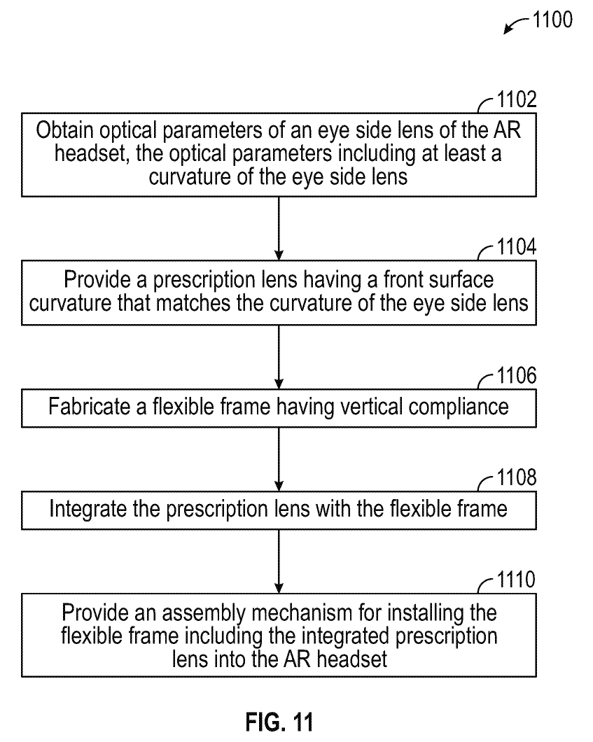

FIG. 11 shows example operations in a method 1100 for integrating prescription correction into an augmented reality (AR) headset. In operation 1102, method 1100 obtains optical parameters of an eye side lens of the AR headset, the optical parameters including at least a curvature of the eye side lens. In operation 1104, method 1100 provides a prescription lens having a front surface curvature that matches the curvature of the eye side lens. In operation 1106, method 1100 fabricates a flexible frame having vertical compliance. In operation 1108, method 1100 integrates the prescription lens with the flexible frame. In operation 1110, method 1100 provides an assembly mechanism for installing the flexible frame including the integrated prescription lens into the AR headset. Further operations are possible, for example as described elsewhere herein.

### Examples

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 includes a prescription lens attachment apparatus for providing prescription correction in an augmented reality (AR) headset, the apparatus comprising: a frame mountable to the AR headset; and at least one prescription lens supported by the frame, the at least one prescription lens having a front surface curvature that matches a curvature of an eye side lens of the AR headset.

Example 2 includes the apparatus of example 1, wherein the at least one prescription lens includes one or more aspheric surfaces.

Example 3 includes the apparatus of example 2, wherein the one or more aspheric surfaces provides a consistent optical power distribution across a portion of the at least one prescription lens.

Example 4 includes the apparatus of any one of examples 1-3, wherein the at least one prescription lens maintains optical performance when decentered by up to 4mm.

Example 5 includes the apparatus of any one of examples 1-4, wherein the frame is flexible and has vertical compliance.

Example 6 includes the apparatus of any one of examples 1-5, wherein the frame is formed from stamped stainless steel.

Example 7 includes the apparatus of any one of examples 1-6, wherein the at least one prescription lens includes one of a groove cut, a T-rim cut, or a metal in line cut that interfaces with the frame.

Example 8 includes a prescription lens for use with an augmented reality (AR) headset, the prescription lens comprising: an optical lens body having a front surface and a rear surface; wherein the front surface has a curvature that matches a curvature of an eye side lens of the AR headset.

Example 9 includes the prescription lens of example 8, wherein at least a portion of the front surface of the prescription lens has a fixed front radius.

Example 10 includes the prescription lens of example 8 or 9, wherein at least a portion of the rear surface of the optical lens body includes one or more aspheric surfaces.

Example 11 includes the prescription lens of example 10, wherein the one or more aspheric surfaces provides a consistent optical power distribution across a portion of the prescription lens.

Example 12 includes the prescription lens of any one of examples 8-11, wherein the prescription lens maintains optical performance when decentered by up to 4 mm.

Example 13 includes an augmented reality (AR) viewing system comprising: an AR headset having an AR lens stack including a waveguide, a negative power lens behind the waveguide, and a positive power lens in front of the waveguide, wherein the negative power lens has an eye side surface with a specific curvature; and a prescription lens apparatus removably attachable to the AR headset, the prescription lens apparatus comprising: a frame; and at least one prescription lens supported by the frame, the at least one prescription lens having a front surface curvature that matches the specific curvature of the eye side surface of the negative power lens of the AR headset.

Example 14 includes the system of example 13, wherein the at least one prescription lens includes one or more aspheric surfaces.

Example 15 includes the system of example 14, wherein the one or more aspheric surfaces provides a consistent optical power distribution across a portion of the at least one prescription lens.

Example 16 includes the system of any one of examples 13-15, wherein the at least one prescription lens maintains optical performance when decentered by up to 4mm.

Example 17 includes the system of any one of examples 13-16, wherein the frame is flexible and has vertical compliance.

Example 18 includes the system of any one of examples 13-17, wherein the frame is formed from stamped stainless steel.

Example 19 includes the system of any one of examples 13-18, wherein the at least one prescription lens includes one of a groove cut, a T-rim cut, or a metal in line cut that interfaces with the frame.

Example 20 includes a method for integrating prescription correction into an augmented reality (AR) headset, the method comprising: obtaining optical parameters of an eye side lens of the AR headset, the optical parameters including at least a curvature of the eye side lens; providing a prescription lens having a front surface curvature that matches the curvature of the eye side lens; fabricating a flexible frame having vertical compliance; integrating the prescription lens with the flexible frame; and providing an assembly mechanism for installing the flexible frame including the integrated prescription lens into the AR headset.

It should be noted that the description and the figures above merely illustrate the principles of the present subject matter along with examples described herein and should not be construed as a limitation to the present subject matter. It is thus understood that various arrangements may be devised that although not explicitly described or shown herein, embody the principles of the present subject matter. Moreover, all statements herein reciting principles, aspects, and implementations of the present subject matter, as well as specific examples thereof, are intended to encompass equivalents thereof.

It is to be understood that not necessarily all objects or advantages may be achieved in accordance with any particular example described herein. Thus, for example, those skilled in the art will recognize that some examples may be operated in a manner that achieves or optimizes one advantage or group of advantages as taught herein without necessarily achieving other objects or advantages as may be taught or suggested herein.

Although the described flow diagrams herein can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

Conditional language such as, among others, “can,” “could,” “might” or “may,” unless specifically stated otherwise, are understood within the context as used in general to convey that some examples include, while other examples do not include, some features, elements and/or steps. Thus, such conditional language is not generally intended to imply that features, elements and/or steps are in any way necessary for examples or that examples necessarily include logic for deciding, with or without user input or prompting, whether these features, elements and/or steps are included or are to be performed in any particular example.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that some examples require at least one of X, at least one of Y, or at least one of Z to each be present.

It should be emphasized that many variations and modifications may be made to the above-described examples, the elements of which are to be understood as being among other acceptable examples. All such modifications and variations are intended to be included herein within the scope of this disclosure.

Unless otherwise explicitly stated, articles such as “a” or “an” should generally be interpreted to include one or more described items. It will also be appreciated that one or more of the elements depicted in the drawings/figures can also be implemented in a more separated or integrated manner, or even removed or rendered as inoperable in certain cases, as is useful in accordance with a particular application.

Thus, while the above is a detailed description of some examples of the inventive subject matter, various alternatives, modifications, and equivalents may be used. Therefore, the above description should not be taken as limiting the scope of the inventive subject matter which is defined by the appended claims.

1. A prescription lens attachment apparatus for providing prescription correction in an augmented reality (AR) headset, the apparatus comprising:
a frame mountable to the AR headset; and
at least one prescription lens supported by the frame, the at least one prescription lens having a front surface curvature that matches a curvature of an eye side lens of the AR headset.

2. The apparatus of claim 1, wherein the at least one prescription lens includes one or more aspheric surfaces.

3. The apparatus of claim 2, wherein the one or more aspheric surfaces provides a consistent optical power distribution across a portion of the at least one prescription lens.

4. The apparatus of claim 3, wherein the at least one prescription lens maintains optical performance when decentered by up to 4mm.

5. The apparatus of claim 1, wherein the frame is flexible and has vertical compliance.

6. The apparatus of claim 5, wherein the frame is formed from stamped stainless steel.

7. The apparatus of claim 1, wherein the at least one prescription lens includes one of a groove cut, a T-rim cut, or a metal in line cut that interfaces with the frame.

8. A prescription lens for use with an augmented reality (AR) headset, the prescription lens comprising:
an optical lens body having a front surface and a rear surface;
wherein the front surface has a curvature that matches a curvature of an eye side lens of the AR headset.

9. The prescription lens of claim 8, wherein at least a portion of the front surface of the prescription lens has a fixed front radius.

10. The prescription lens of claim 8, wherein at least a portion of the rear surface of the optical lens body includes one or more aspheric surfaces.

11. The prescription lens of claim 10, wherein the one or more aspheric surfaces provides a consistent optical power distribution across a portion of the prescription lens.

12. The prescription lens of claim 11, wherein the prescription lens maintains optical performance when decentered by up to 4 mm.

13. An augmented reality (AR) viewing system comprising:
an AR headset having an AR lens stack including a waveguide, a negative power lens behind the waveguide, and a positive power lens in front of the waveguide, wherein the negative power lens has an eye side surface with a specific curvature; and
a prescription lens apparatus removably attachable to the AR headset, the prescription lens apparatus comprising:
a frame; and
at least one prescription lens supported by the frame, the at least one prescription lens having a front surface curvature that matches the specific curvature of the eye side surface of the negative power lens of the AR headset.

14. The system of claim 13, wherein the at least one prescription lens includes one or more aspheric surfaces.

15. The system of claim 14, wherein the one or more aspheric surfaces provides a consistent optical power distribution across a portion of the at least one prescription lens.

16. The system of claim 15, wherein the at least one prescription lens maintains optical performance when decentered by up to 4mm.

17. The system of claim 13, wherein the frame is flexible and has vertical compliance.

18. The system of claim 17, wherein the frame is formed from stamped stainless steel.

19. The system of claim 13, wherein the at least one prescription lens includes one of a groove cut, a T-rim cut, or a metal in line cut that interfaces with the frame.

20. A method for integrating prescription correction into an augmented reality (AR) headset, the method comprising:
obtaining optical parameters of an eye side lens of the AR headset, the optical parameters including at least a curvature of the eye side lens;
providing a prescription lens having a front surface curvature that matches the curvature of the eye side lens;
fabricating a flexible frame having vertical compliance;
integrating the prescription lens with the flexible frame; and
providing an assembly mechanism for installing the flexible frame including the integrated prescription lens into the AR headset.
